(19) United States
(12) Patent Application Publication
(10) Pub. No.: US 2026/0205894 A1
(43) Pub. Date: Jul. 16, 2026

(54) CSSF Design for SSB-less SCell Operation

(71) Applicant: Apple Inc.

(72) Inventors: Jie Cui, San Jose, CA (US); Peng Cheng, Beijing (CN); Yang Tang, San Jose, CA (US); Qiming Li, Beijing (CN); Dawei Zhang, Saratoga, CA (US); Dan Wu, Beijing (CN)

(21) Appl. No.: 18/861,533

(22) PCT Filed: Oct. 31, 2023
(86) PCT No.: PCT/CN2023/128649

§ 371 Date: Oct. 29, 2024

(51) Int. Cl. H04W 36/00

(52) U.S. Cl. CPC H04W 36/0058; H04W 36/0069; H04W 36/0072

(57) ABSTRACT

An apparatus of a user equipment (UE) comprising one or more processors configured to identify, at the UE, one or more measurement objects (MOs) configured for a primary secondary component carrier (PSCC) of a primary secondary cell (PSCell) in an EN-DC network with carrier aggregation (CA); determine, at the UE, a carrier-specific scaling factor (CSSF) value to scale a measurement delay requirement, wherein the CSSF value is for measurements of the MOs conducted outside measurement gaps (MGs) and derived from the PSCell, the CSSF value is: increased when the PSCell includes a synchronization signal block (SSB), and not increased when the PSCell is without an SSB (SSB-less); measure, at the UE, the MOs outside the MGs based on the measurement delay scaled by the CSSF value; and encode, at the UE, one or more measurement reports (MRs) for the one or more MOs for transmission from the UE.

### FIELD

Embodiments of the invention relate to wireless communications, including apparatuses, systems, and methods for application of a carrier-specific scaling factor (CSSF) without a synchronization signal block (SSB-less) secondary cell (SCell) operation in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE.

Consequently, efforts are being made in ongoing developments of 5G-NR to take advantage of higher throughputs possible at higher frequencies.

A carrier-specific scaling factor (CSSF) scales the measurement delay requirement when the user equipment (UE) is configured to monitor multiple measurement objects (MOs) outside measurement gaps (MGs). The CSSF accounts for the number of measurement objects and is based, in part, on cells having a configured synchronization signal block (SSB).

### SUMMARY

Embodiments relate to wireless communications, and more particularly to apparatuses, systems, and methods for an apparatus of a user equipment (UE), the apparatus comprising: one or more processors configured to identify, at the UE, one or more measurement objects (MOs) in an Evolved Universal Terrestrial Radio Access (E-UTRA)-New Radio (NR) Dual Connectivity (EN-DC) network with carrier aggregation (CA); wherein the one or more MOs comprise at least one MO configured for a primary secondary component carrier (PSCC) of a primary secondary cell (PSCell); determine, at the UE, a carrier-specific scaling factor (CSSF) value to scale a measurement delay requirement, wherein the CSSF value is for measurements of the MOs conducted outside measurement gaps (MGs) and derived from the PSCell, wherein the CSSF value is: increased when the PSCell includes a synchronization signal block (SSB), and not increased when the PSCell is without an SSB (SSB-less); measure, at the UE, the one or more MOs outside the MGs based on the measurement delay scaled by the CSSF value; and encode, at the UE, one or more measurement reports (MRs) for the one or more measurement objects for transmission from the UE; and a memory coupled to the one or more processors.

Other embodiments relate to an apparatus of a user equipment (UE), the apparatus comprising: one or more processors configured to: identify, at the UE, one or more measurement objects (MOs) in a stand-alone (SA) new radio (NR) network with carrier aggregation (CA); wherein the one or more MOs comprise at least one MO configured for a primary component carrier (PCC) of a primary cell (PCell); determine, at the UE, a carrier-specific scaling factor (CSSF) value to scale a measurement delay requirement, wherein the CSSF value is for measurements of the MOs conducted outside measurement gaps (MGs) and derived from the PCell, wherein the CSSF value is: increased when the PCell includes a synchronization signal block (SSB), and not increased when the PCell is without an SSB (SSB-less); measure, at the UE, the one or more MOs outside the MGs based on the measurement delay scaled by the CSSF value; and encode, at the UE, one or more measurement reports (MRs) for the one or more measurement objects for transmission from the UE; and a memory coupled to the one or more processors.

Other embodiments relate to an apparatus of a user equipment (UE), the apparatus comprising: one or more processors configured to: identify, at the UE, multiple measurement objects (MOs) in a network configured for frequency range 1 (FR1) with carrier aggregation (CA); wherein the multiple MOs comprise MOs configured for multiple secondary component carriers (SCCs) of multiple secondary cells (SCells); determine, at the UE, a carrier-specific scaling factor (CSSF) value to scale a measurement delay requirement, wherein the CSSF value is for measurements of the MOs conducted outside measurement gaps (MGs) and derived from the SCells, wherein the CSSF value is: increased and scaled when the SCells include a synchronization signal block (SSB), and increased and not scaled when the SCells are without an SSB (SSB-less); measure, at the UE, the one or more MOs outside the MGs based on the measurement delay scaled by the CSSF value; and encode, at the UE, one or more measurement reports (MRs) for the multiple MOs for transmission from the UE; and a memory coupled to the one or more processors.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE according to some embodiments.

FIG. 7 illustrates an example block diagram of an interface of baseband circuitry according to some embodiments.

FIG. 8 illustrates an example block diagram of a control plane protocol stack according to some embodiments.

FIG. 9 illustrates an example of an Evolved Universal Terrestrial Radio Access (E-UTRA)-New Radio (NR) Dual Connectivity (EN-DC) network according to some embodiments.

FIG. 10 illustrates an example of a Carrier Aggregation (CA) system according to some embodiments.

FIG. 11 illustrates an example of a Carrier Aggregation (CA) system according to some embodiments.

FIG. 12 illustrates an example of a Carrier Aggregation (CA) system according to some embodiments.

FIG. 13 illustrates an example derivation of a Carrier-Specific Scaling Factor (CSSF) according to some embodiments.

FIG. 14 illustrates an example method for deriving a CSSF according to some embodiments.

FIG. 15 illustrates an example method for deriving a CSSF according to some embodiments.

FIG. 16 illustrates an example derivation of a CSSF according to some embodiments.

FIG. 17 illustrates an example method for deriving a CSSF according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

The example embodiments may be further understood with reference to the following description and the related appended drawings, wherein like elements are provided with the same reference numerals. The example embodiments relate to configuring RRM measurement for UEs without gap.

The example embodiments are described with regard to communication between a next generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support gapless RRM measurements. Therefore, the gNB or UE as described herein is used to represent any appropriate type of electronic component.

The example embodiments are also described with regard to a fifth generation (5G) New Radio (NR) network that may configure a UE to perform measurements of a target SSB with no-gap and with-interruption, or no-gap and no-interruption. However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

The example embodiments provide various manners for a network to determine whether a UE supports gapless RRM measurements. The determination may be based on a dependency between different categories or types of RRM measurements that the UE may be configured to perform. The example embodiments are described in greater detail below.

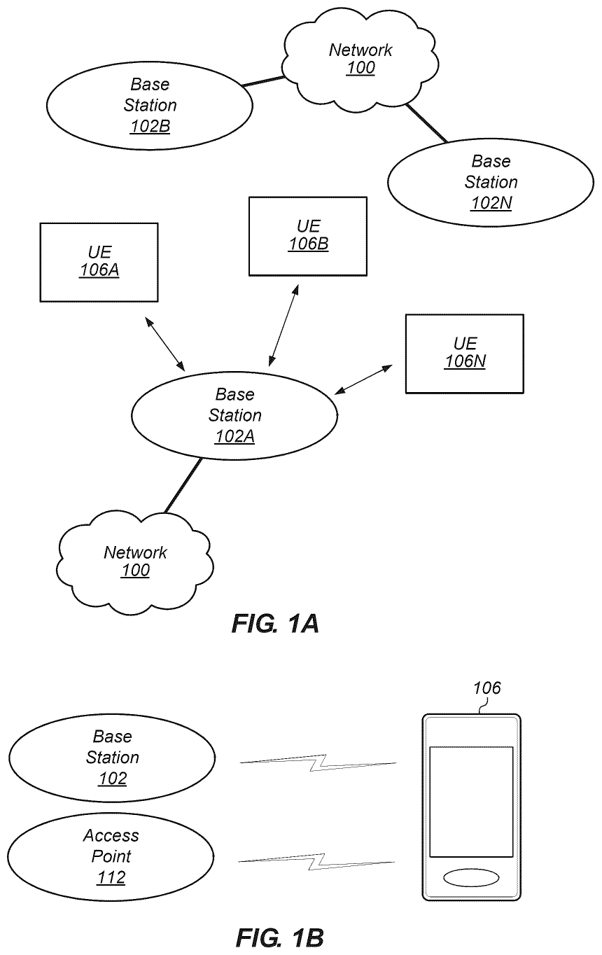

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base stations 102 can be configured for inter-band SSB-less carrier aggregation, as further described herein. One base station 102A may be a primary cell (PCell) with a radio resource control (RRC) connection, while another base station 102N may be a secondary cell (SCell) that is configured for inter-band and non-contiguous communication without a synchronization signal block (SSB-less).

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

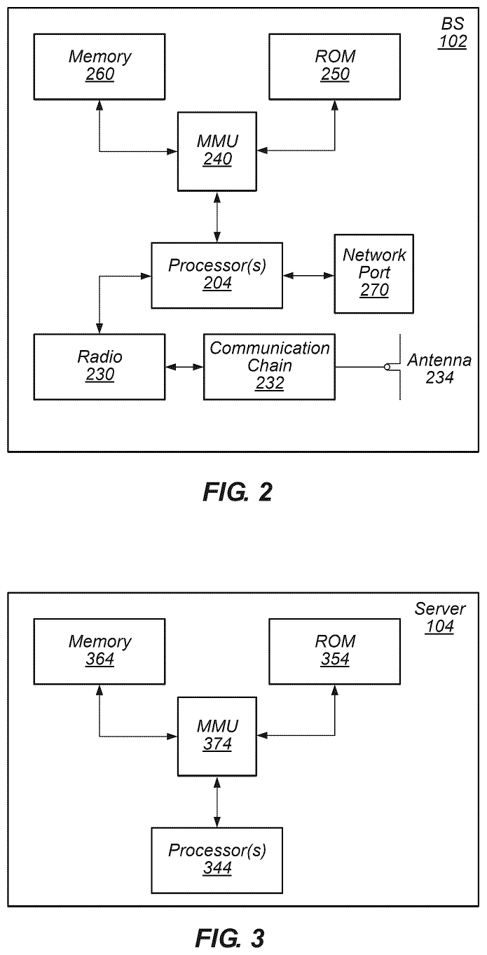

FIG. 2: Block Diagram of a Base Station FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to decode indications from the UE 106, determine UE capabilities based on the indications, and encode for transmission to the UE 106 downlink signals to enable the UE 106 to perform measurements of the target SSB without gap or gapless measurement.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

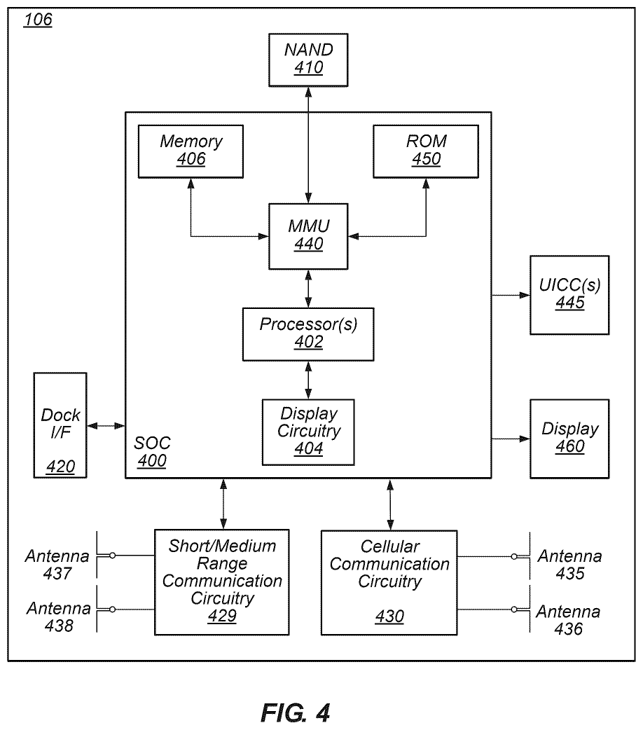

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402. Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 thereof can be configured to and/or capable of performing various operations related to reporting a UE capability for NFG and NCSG gapless measurement, as described herein.

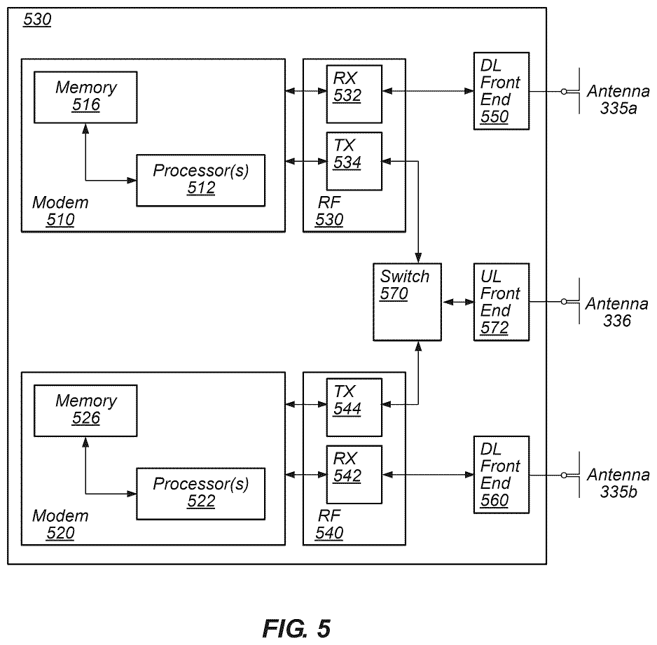

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for inter-band SSB-less carrier aggregation, as further described herein.

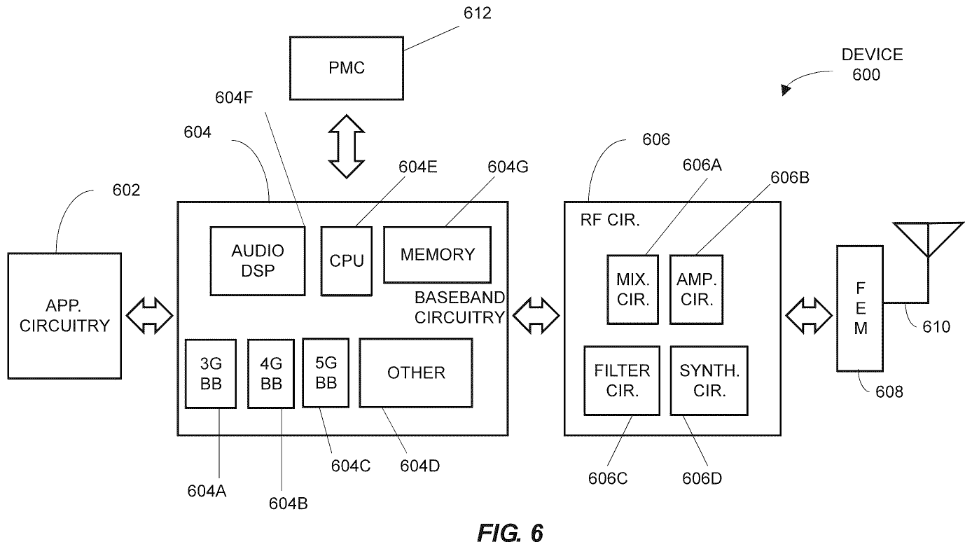

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

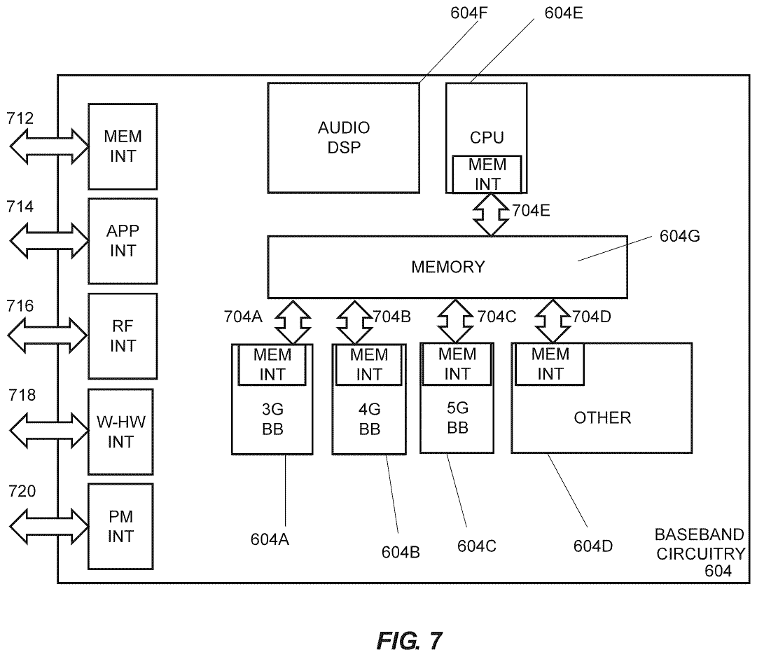

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 7914 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

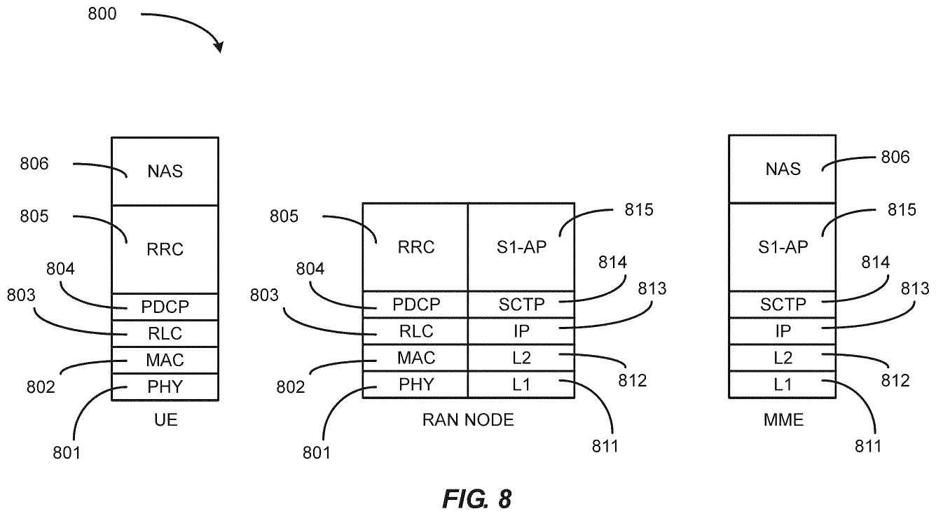

### FIG. 8: Block Diagram of a Control Plane Protocol Stack

FIG. 8 is an illustration of a control plane protocol stack in accordance with some embodiments. It is noted that the stack of FIG. 8 is merely one example of a possible stack, and that features of this disclosure may be implemented in any of various systems, as desired.

In this embodiment, a control plane 800 is shown as a communications protocol stack between the UE 106, a RAN node, and a MME.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation, and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 106 and the RAN node may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 106 and the MME. The NAS protocols 806 support the mobility of the UE 106 and the session management procedures to establish and maintain IP connectivity between the UE 106 and the P-GW.

The S1 Application Protocol (S1-AP) layer 815 may support the functions of the S1 interface and comprise Elementary Procedures (EPS). An EP is a unit of interaction between the RAN node and the CN. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node and the MME based, in part, on the IP protocol, supported by the IP layer 813. The L2 layer 812 and the L1 layer 811 may refer to communication links (e.g., wired or wireless) used by the RAN node and the MME to exchange information.

The RAN node and the MME may utilize an S1-MME interface to exchange control plane data via a protocol stack comprising the L1 layer 811, the L2 layer 812, the IP layer 813, the SCTP layer 814, and the S1-AP layer 815.

The various layers illustrated in the example of FIG. 8 can be used to provide signaling between a UE and one or more nodes. One area in which signaling is used is to establish the use of carrier aggregation (CA) for communication between a UE and multiple nodes. Carrier Aggregation can enable higher data rates between for a UE. Higher data rates are one of the key promises in the implementation of the fifth generation (5G) of the 3GPP standard.

However, as 5G is becoming pervasive across industries and geographical areas, handling more advanced services and applications using high data rates, networks are being denser, use more antennas, with larger bandwidths and more frequency bands. This results in greater amounts of energy used at the UE, thereby reducing battery life at the UE. As previously discussed, one means for reducing power consumption is through the use of groups of cells used in carrier aggregation to include a secondary cell (SCell) that does not include an SSB. In addition, the SSB-less SCell may be designated for only UL communication. The inclusion of an SSB-less SCell in CA can reduce the amount of power consumed by the UE communicating with each SSB. But it also necessitates specific signaling to enable the UE to communicate with the SSB-less SCell, possibly only using UL signals.

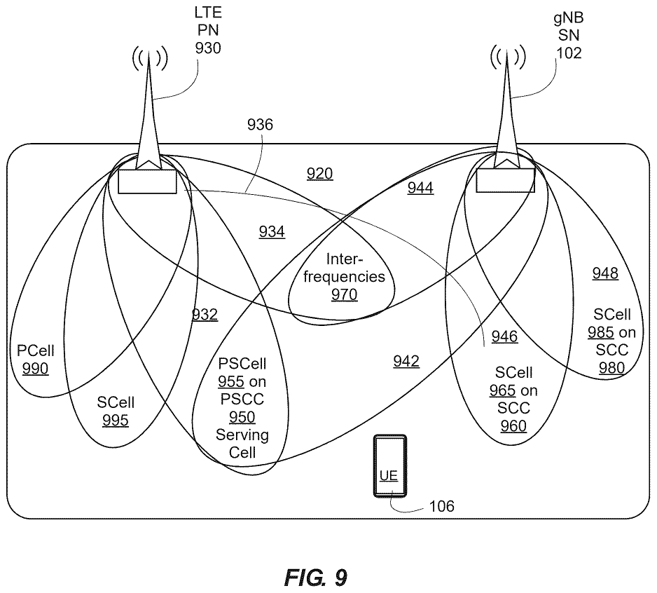

### FIG. 9: Schematic Diagram of a Dual Connectivity System

FIG. 9 illustrates a simplified example dual connectivity system, according to some embodiments. It is noted that the system of FIG. 9 is merely one example of a possible system, and that features of this disclosure may be implemented in any of various systems, as desired.

An E-UTRA-New Radio (NR) Dual Connectivity (EN-DC) network 920 communicating with a user equipment (UE) 106 can request that the UE 106 collect measurements of neighboring cells. The network 920 can configure a measurement object (MO) and transmit the MO to the UE via Layer 3 signaling, such as radio resource control (RRC) signaling. The UE 106 can collect the measurements according to the MO and provide the measurements to the network 920. The network 920 can use the measurements to adjust settings and improve service to the UE 106. A UE 106 can operate in a portion of a channel bandwidth, referred to as a bandwidth part (BWP). The gNB can assign the UE to use multiple different BWPs, where one BWP is active at a time. When an MO is to be measured on a frequency outside of the active BWP, the MO may be performed during a Measurement Gap (MG). When the MO is to be measured on a frequency within the active BWP, or on a separate receive chain at the UE, the MO is considered to be an MO outside an MG, or an MO without MG.

Some embodiments enable a UE 106 to manage radio resources to process one or more MOs outside MGs within a selected frequency range, such as Frequency Range 1 (FR1), comprising carriers within 450 MHz to 6 GHz.

The EN-DC network 920 can include two types of Radio Access Technologies (RAT): Long Term Evolution (LTE) with Primary Node (PN) 930 and New Radio (NR) or gNB with Secondary Node (SN) 102. Examples of NR include but is not limited to 5G communications as defined by 3rd Generation Partnership Project (3GPP) standards. The PN 930 can manage the LTE portions of EN-DC network 920 including but not limited to: Primary Cell (PCell) 990 and a Secondary Cell (SCell) 995. The SN 102 can manage NR portions of EN-DC network 920 including but not limited to: Primary Secondary Cell (PSCell) 955 corresponding to a secondary cell group (SCG) comprising Primary Secondary Component Carrier (PSCC) 950; SCell 965 corresponding to Secondary Component Carrier (SCC) 960 and SCell 985 that operates on SCC 980. Cells that have a component carrier that operates in a frequency band outside of the frequency band of the primary component carrier (or primary secondary component carrier, when it is active) are referred to as inter-frequency 970.

The PSCell 955 can be the current serving cell for the UE 106. The PN 930 and the SN 102 can configure the UE 106 to process NR MOs without MGs. For example, the SN 102 can configure the UE 106 to process intra-RAT NR MOS without MGs including: intra-frequency NR MOs without MGs illustrated as information 942, 946, and 948; and inter-frequency NR MOs without MGs illustrated as information 944. The PN 930 can configure the UE 106 to process inter-RAT frequency NR MOs without MGs that include: intra-frequency NR MOs without MGs illustrated as information 932 and 936. Although not shown, an intra-frequency NR MO without MG can also be configured for SCC 980; and inter-frequency NR MOs without MGs illustrated as information 934. These are described further in FIGS. 3 and 4 below.

The following CA scenarios are possible: FR1; intra-band FR2; and a combination of FR1 and FR2 where FR2 includes the PSCell. For example, in the FR1 CA scenario, PSCC 950, SCC 960, SCC 980, and inter-frequencies 970 are in FR1. In the FR2 CA scenario, PSCC 950, SCC 960, SCC 980, and inter-frequencies 970 are in FR2. In the combination of FR1 and FR2 where FR2 includes the PSCell CA scenario, PSCC 950 is in FR2. SCC 960 and/or SCC 980 can operate in FR1 or FR2.

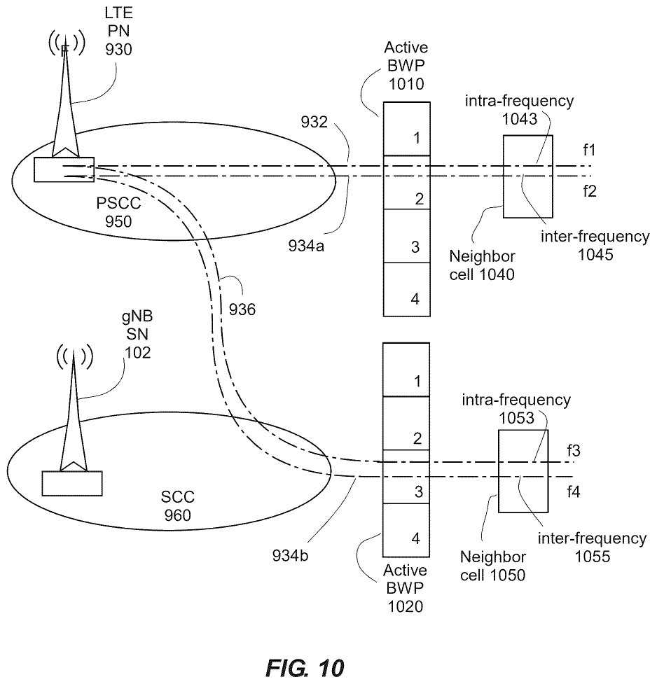

### FIG. 10: Schematic Diagram of Carrier Aggregation

FIG. 10 illustrates a simplified example of carrier aggregation (CA), according to some embodiments. It is noted that the system of FIG. 10 is merely one example of a possible system, and that features of this disclosure may be implemented in any of various systems, as desired.

FIG. 10 illustrates an example of CA of Primary Secondary Component Carrier (PSCC) 950 and Secondary Component Carrier (SCC) 960. The PSCC 950 includes four BWPs where BWP 2 is the Active BWP 910. The serving carrier frequency for PSCC is f1. The SCC 960 includes four BWPs where BWP 3 is the Active BWP 1020. The serving carrier frequency for SCC is f3. As shown, neighboring cell 1040 also operates on frequencies f1 and f2. Neighboring cell 1050 also operates on frequencies f3 and f4,

When UE 106 collects measurements for an NR MO on a frequency outside of Active BWP 1010 or Active BWP 1020, the NR MO measurements are collected during a defined time period called a Measurement Gap (MG). When UE 106 collects measurements for an NR MO outside of an MG, or in other words, the measurements are collected during Active BWP 1010 or Active BWP 1020, the NR MO is called an NR MO without MG. The UE can also collect measurements for an NR MO outside of the MG using a separate receive chain.

The PN 1030 can configure UE 106 to process inter-RAT frequency NR MOs without MGs that can include: an intra-frequency NR MO without MG, and/or an inter-frequency NR MO without MG. To process an intra-frequency NR MO without MG, the UE 106 can collect measurements on a serving carrier frequency such as f1 for PSCC 950 and f3 for SCC 960. Information 932 illustrates information associated with a first intra-frequency NR MO without MG from PN 930 associated with the serving carrier frequency, f1, of PSCC 950. When the UE 106 processes the first intra-frequency NR MO without MG at f1, the UE 106 can collect measurements during a Synchronization Signal Block (SSB) of neighboring cell 1040 noted as intra-frequency 1043. Information 936 illustrates information associated with a second intra-frequency NR MO without MG from the PN 930 associated with the serving carrier frequency, f3, of the SCC 960. When the UE 106 processes the second intra-frequency NR MO without MG at f3, the UE 106 can collect measurements during an SSB of neighboring cell 1050 noted as intra-frequency 1053.

To process an inter-frequency NR MO without MG from the PN 930, the UE 106 collects measurements on a frequency within an Active BWP that is not a serving carrier frequency. For example, an inter-frequency in Active BWP 1010 cannot be serving carrier frequency such as f1 for the PSCC 950, or in Active BWP 1020, cannot be serving carrier frequency f3 for the SCC 960. Information 934a illustrates information associated with a first inter-frequency NR MO without MG from the PN 930 associated with the serving carrier frequency, f1, of the PSCC 950. When the UE 106 processes the inter-frequency NR MO without MG at f1, the UE 106 can collect measurements during an SSB of neighboring cell 1040 noted as inter-frequency 1045. Information 934b illustrates information associated with a second inter-frequency NR MO without MG from the PN 930 associated with the serving carrier frequency, f3, of the SCC 960. When the UE 106 processes the inter-frequency NR MO without MG at f3, the UE 106 can collect measurements during an SSB of neighboring cell 1050 noted as inter-frequency 1055. In some embodiments an inter-frequency NR MO without MG is associated with a CC (e.g., the PSCC 950 or the SCC 960) and/or a serving carrier frequency (e.g., f1 or f3).

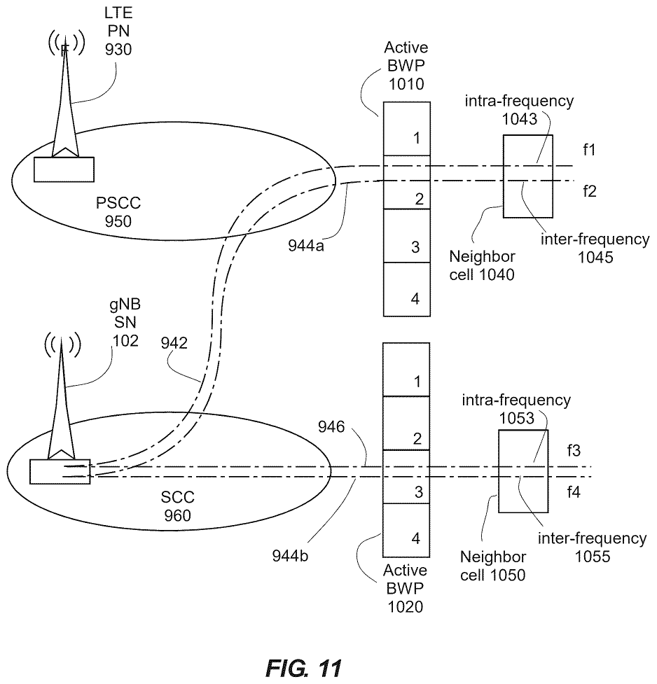

### FIG. 11: Schematic Diagram of Carrier Aggregation

FIG. 11 illustrates a simplified example of carrier aggregation (CA), according to some embodiments. It is noted that the system of FIG. 11 is merely one example of a possible system, and that features of this disclosure may be implemented in any of various systems, as desired.

FIG. 11 illustrates an example of information associated with an intra-RAT NR MO without MG, according to some embodiments of the disclosure. The SN 102 can configure the UE 106 to process intra-RAT NR MO without MG including: intra-frequency MOs without MGs illustrated as information 942, 946, and 948 of FIG. 8; and inter-frequency NR MOs without MGs illustrated as information 944. To process an intra-frequency NR MO without MG from the SN 102, the UE 106 collects measurements at a serving carrier frequency, such as f1 for the PSCC 950 and f3 for the SCC 960. Information 942 illustrates information associated with a first intra-frequency NR MO without MG from the SN 102 associated with the serving carrier frequency, f1, of the PSCC 950. When the UE 106 processes the intra-frequency NR MO without MG at f1, the UE 106 can collect measurements during an SSB of neighboring cell 1040 noted as intra-frequency 1043. Information 946 illustrates information associated with a second an intra-frequency NR MO without MG from the SN 102 associated with the serving carrier frequency, f3, of the SCC 960. When the UE 106 processes the intra-frequency NR MO without MG at f3, the UE 106 can collect measurements during an SSB of neighboring cell 1050 noted as intra-frequency 353.

To process an inter-frequency NR MO without MG from the SN 102, the UE 106 collects measurements on a frequency within an Active BWP that is not a serving carrier frequency. For example, an inter-frequency in Active BWP 1010 cannot be serving carrier frequency such as f1 for the PSCC 950, or in Active BWP 1020, cannot be serving carrier frequency f3 for the SCC 960. Information 944a illustrates information associated with a first inter-frequency NR MO without MG from the SN 102 associated with the serving carrier frequency, f1, and/or the PSCC 950. When the UE 106 processes the inter-frequency NR MO without MG at f1 and/or the PSCC 950, the UE 106 can collect measurements during an SSB of neighboring cell 1040 noted as inter-frequency 1045. Information 944b illustrates information associated with a second inter-frequency NR MO without MG from the SN 102 associated with the serving carrier frequency, f3, and/or the SCC 960. When the UE 106 processes the inter-frequency NR MO without MG at f3 and/or the SCC 960, the UE 106 can collect measurements during a SSB of neighboring cell 1050 noted as inter-frequency 1055.

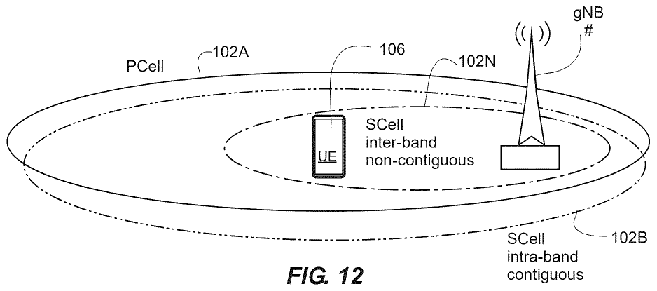

### FIG. 12: Schematic Diagram of a Carrier Aggregation System

FIG. 12 illustrates a simplified example carrier aggregation system, according to some embodiments. It is noted that the system of FIG. 12 is merely one example of a possible system, and that features of this disclosure may be implemented in any of various systems, as desired.

FIG. 12 illustrates multiple different CA possibilities. In one example, the UE 106 can be in communication with a PCell 102A. The PCell 102A can be designated as the active serving cell for the UE 106. The UE 106 can also be in communication, using CA, with a secondary cell 102B that can be co-located with the PCell 102A. The component carriers (CC) for the SCell can be intra-band contiguous with the component carriers of the PCell. The UE 106 can obtain timing information and L3 measurements from the serving cell, such as the PCell 102A in this example, which can be used by the UE 106 to communicate with the SSB-less SCell 102B.

When communicating using an intra-band SSB-less Scell the active serving cell can be used to acquire timing to communicate with the SSB-less Scell. With intra-band, the active serving cell has intra-band contiguous component carrier (CC) relative to the target SSB-less secondary component carriers (SCC). The serving cell can be a primary cell (PCell), a primary cell in a secondary cell group (PSCell), or an SCell that is in the same band as the target SCC, with CC that are contiguous to the target SCC.

In another embodiment, the cells 102 in FIG. 12 can be configured for CA communication with the UE 106 using inter-band SSB-less communication with an SCell. In this example, the UE 106 can be configured for CA to communicate with the PCell 102A and an SCell 102N. The component carriers assigned for the UE to communicate with the SCell 102N can be in a different band (i.e. band B) than the band of the component carriers assigned for the UE to communicate with the PCell 102A (i.e. band A). Since the component carriers of the PCell 102A and the SCell 102N are in different bands, they are, by definition, not contiguous. If the SCell 102N in this example does not include an SSB, then inter-band SSB-less communication may use different signaling than is used with intra-band SSB-less communication to enable the UE 106 to obtain the timing and L3 measurements to communicate with the SSB-less SCell 102N.

### CSSF for SSB-Less SCell Operation

The operation without synchronization signal block (SSB-less) secondary cell (SCell) for Layer 3 (L3) measurement can have some options. In one option, the L3 measurement is not needed on the SSB-less SCell. For SSB-less SCell activation, when the conditions about received time difference (RTD) (i.e. between the SSB-less SCell and the FR1 inter-band active serving call), power imbalance and tracking reference signal (TRS) are met, the L3 measurement can be skipped. Alternatively, the UE may not be required to perform SSB-based L1/L3 measurements on the SSB-less SCells. In another option, if the conditions are not met but channel state information reference signal (CSI-RS) based measurement is supported and configured, L3 measurement may need to be specified for SSB-less SCell operation. The CSI-RS based L3 measurement may be supported for the SSB-less SCell. The known/unknown condition of the SCell can be defined based on the L3 measurement reporting (MR) of the CSI-RS based L3 measurement. There may be an impact on the CSI-RS based L1/L3 measurement requirements due to SSB-less SCell operation. Even though the SSB is not transmitted on the SCell, the network can still configure CSI-RS for L3 radio resource management (RRM) measurement on the secondary component carrier (SCC), including serving cell measurement and neighbor cell measurement.

A carrier-specific scaling factor (CSSF) can be used to scale measurement resource coordination among the different serving component carriers (CC) for intra-frequency L3 radio resource management (RRM) measurement. A user equipment (UE) may be requested to measure a number of carriers. The UE can coordinate the measurement resources among the carriers. In the third generation partnership project (3GPP), the minimum requirement is to have the ability to perform at least two searches in parallel. So the UE can only measure two carriers in parallel. When there are additional carriers, some of the carriers may be prioritized. For example, the UE can allocate one searcher for one carrier, such as the carrier for the PCC, but the UE may need to share the other searcher for all the other carriers. The CSSF can be used for resource sharing. The Release 18 (R18) of the 3GPP standards introduced network energy savings in which a network may disable or mute some signal transmissions, such as synchronization signal blocks (SSB) that will not be received at the UE. Such a cell (e.g. a secondary cell (SCell)) may be known as SSB-less, or an SSB-less SCell. Thus, there is a need to introduce a new, unique behavior or method to work with such SSB-less SCells.

When a Layer 3 (L3) measurement is configured for an SSB-less SCell based on a channel status information-reference signal (CSI-RS), or a CSI-RS based L3 measurement, the treatment or handling of the measurement may be varied because the CSSF was previously based on a cell (e.g. SCell) having both an SSB and a CSI-RS based L3 measurement configuration but now the SSB may be muted so the UE can only see the CSI-RS.

As discussed above, the legacy carrier-specific scaling factor (CSSF) can be used to coordinate the measurement resource among the different serving component carriers (CCs) for intra-frequency L3 RRM measurement. For example, in a scenario in FR1 with carrier aggregation (CA) and stand-alone (SA) mode, the scaling factor can be determined as shown in Table 1.

TABLE 1
Scaling Factor for SA Mode

| | |
|---|---|
| CSSF_{outside}_{_{—}}_{gap, i} | 1 + N_{PCC}_{_{—}}_{CSIRS} + |
| for FR1 PCC | N_{PCC}_{_{—}}_{CCA}_{_{—}}_{RRSI/CO} |
| CSSF_{outside}_{_{—}}_{gap, i} | N_{SCC}_{_{—}}_{SSB} + Y + 2x N_{PCC}_{_{—}}_{CSIRS} + |
| for FR1 SCC | N_{PCC}_{_{—}}_{CCA}_{_{—}}_{RRSI/CO} |
| CSSF_{outside}_{_{—}}_{gap, i} | N/A |
| for FR2 PCC | |
| CSSF_{outside}_{_{—}}_{gap, i} | N/A |
| for FR2 SCC | |
| where neighbor cell measurement | |
| is required | |
| CSSF_{outside}_{_{—}}_{gap, i} | N/A |
| for FR2 SCC | |
| where neighbor cell measurement | |
| not is required | |
| CSSF_{outside}_{_{—}}_{gap, i} | N_{SCC}_{_{—}}_{SSB} + Y + 2x N_{PCC}_{_{—}}_{CSIRS} |
| for inter-frequency MO with no | |
| MG | |

In Table 1, Y is the number of configured inter-frequency measurement object (MOs) without measurement gap (MG) that are being measured outside of the MG; otherwise, it is 0. N_{PCC_CSIRS}=1 if the PCC is with either both SSB and CSI-RS based L3 measurements configured or only CSI-RS based L3 measurements configured; otherwise, N_{PCC_CSIRS}=0. N_{SCC_CSIRS}=the number of configured SCell(s) with either both SSB and CSI-RS based L3 measurement configured or only CSI-RS based L3 measurement configured. N_{SCC_SSB}=number of configured SCell(s) with only SSB based L3 measurement configured, which is measured without the MG. N_{PCC_CCA_RSSI/CO}=1 if the primary secondary component carrier (PSCC) is configured with received signal strength indicator/channel occupancy (RSSI/CO) measurements without MG when RSSI measurement timing configuration (RMTC) and SSB-based RRM measurement timing configuration (SMTC) are overlapping; N_{SCC_CCA_RSSI/CO}=number of MOs for SCell(s) configured with RSSI/CO measurements without MG when RMTC and SMTC are overlapping.

As seen in Table 1, different components can have different values based on the determination outlined in the table for the CSSF. The CSSF is used to determine the measurement period for the UE. The time for the measurement can be based on a baseline time period multiplied by the CSSF to obtain the total time period needed to complete the measurement. The baseline measurement on each CC may need a physical averaging from multiple samples to complete the measurement. For example, with five samples to do the average, five times the sample periodicity to give the baseline time. Then the measurement resource can be coordinated. For example, for ten CCs the scaling factor can be ten so that the baseline time can be multiplied by ten for a total time delay for the UE to complete the ten measurements of the ten CCs.

The values of each component in the table can be determined based on the conditions. For example, the component N_{PCC_CSIRS} can be equal to 1 if the PCC is with either both SSB and CSI-RS based L3 measurement configured or only CSI-RS based L3 measurement configured; otherwise, N_{PCC_CSIRS}=0. As described above, the UE can be configured to perform two searches in parallel. For a primary cell (PCell) measurement, a dedicated searcher can be allocated. The PCell can have both SSB and CSI-RS based L3 measurements configured which may not be performed simultaneously. So, the SSB based measurement can be performed first and then the CSI-RS based L3 measurement can be performed. In the time domain, the total delay would be the SSB measurement period plus the CSI-RS based measurement period because they are done in sequential order, not simultaneously. When the component N_{PCC_CSIRS} equals 1, then the terms “1+N_{PCC_CSIRS}” equals 2 (i.e. 1+1=2) with the term “1” being for the baseline time period for the SSB based measurement; so that 2 times the baseline time period is required to complete the measurement of both the SSB based measurement and the CSI-RS measurement. When the PCell has only CSI-RS based L3 measurement configured, timing information may still be needed from an SSB based measurement. So, whether the PCell has both an SSB and CSI-RS based L3 measurement configured or only a CSI-RS based L3 measurement configured, the same time is required (i.e. N_{PCC_CSIRS}=1 in both scenarios). When measurement is performed on SCC, however, the SCC does not have a dedicated searcher. The PCC has a dedicated searcher, but the other searcher is shared by all the SCCs. The component N_{SCC_CSIRS} equals the number of configured SCell(s). Again, the component N_{SCC_CSIRS}=number of configured SCell(s) with either both SSB and CSI-RS based L3 measurement configured or only CSI-RS based L3 measurement configured. If a CSI-RS based L3 measurement is configured on a legacy SCell (with SSB), the SSB will also be used for the timing source for CSI-RS L3 measurement, and thus measurement resource will be allocated for both SSB and CSI-RS even though only the CSI-RS L3 measurement is configured on that SCC.

If, however, in the scenario where the SCell is an SSB-less SCell and a CSI-RS L3 measurement is configured on this SSB-less SCell (and there is no way for the UE to measure this SCell to get the timing information), the CSI-RS based L3 measurement can refer to the timing of an SSB on other serving cell. Therefore, measurement of the SSB-less SCell will only focus on the CSI-RS based L3 measurement. Accordingly, some part of the CSSF can be reduced. Based on the above analysis, the scaling factor (CSSF) for measurement delay shall not have “2×” factor for the component N_{SCC_CSIRS} but will instead have a unity or 1× factor for SSB-less SCells.

If the serving SCell is in network energy saving (NES) mode, and some neighbor cells on the SCC are not in NES mode (the cell(s) have SSB transmission), but other cells on this SCC are SSB-less, then the UE behavior may need to be clarified. For example, if the serving SCell is SSB-less, the neighbor cell on this CC will not use SSB for RRM measurement. As another example, if the serving SCell is SSB-less, the network (NW) may need to indicate to the UE the cell list of the SCCs which are using SSB and/or not using SSB. If the SSB is configured on a neighbor cell of the SCC, then the NW may need to also clarify intra-frequency and inter-frequency measurements. If the CSI-RS is configured, but the serving cell has not configured the CSI-RS, then the NW may also need to clarify intra-frequency and inter-frequency measurement.

As described herein, a carrier-specific scaling factor (CSSF) is designed for CSI-RS L3 measurement on an SSB-less SCell. In addition, also described herein is measurement on neighbor cell(s) which have SSBs. This may include a new definition for intra-frequency and inter-frequency, and/or UE behavior on which reference signal (RS) shall be used for mobility.

The CSFF pertains to resource management and is a value that scales the measurement delay requirements given when UE is configured to monitor multiple measurement objects (MO). The CSSF values are categorized into CSSF_{outside_gap,i} and CSSF_{within_gap,i}, for the measurements conducted outside measurement gaps and within measurement gaps, respectively. A UE can be expected to conduct the measurement of this measurement object “i” only outside the measurement gaps.

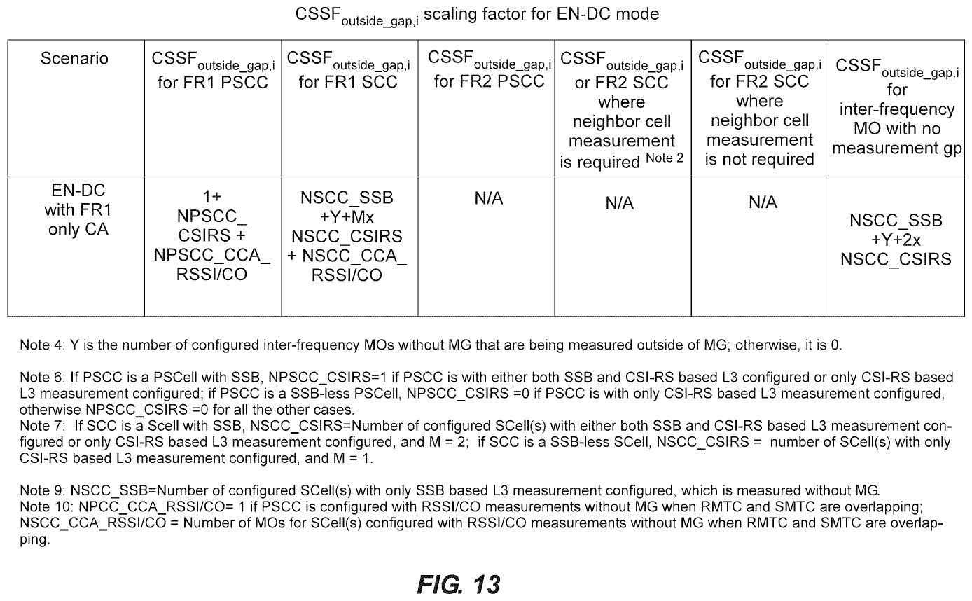

### FIG. 13: CSSF Redesigned for EN-DC FR1 Only CA Scenario

FIG. 13 illustrates example derivations of CSSF values. It is noted that the CSSF derivation of FIG. 13 is merely one example, and that features of this disclosure may be implemented in any of various systems, as desired.

FIG. 13 illustrates derivations of CSSF values in an Evolved Universal Terrestrial Radio Access (E-UTRA)-New Radio (NR) Dual Connectivity (EN-DC) network configured for frequency range 1 (FR1) with carrier aggregation (CA). In one aspect, the CSSF values can be derived for a primary secondary component carrier (PSCC) of a primary secondary cell (PSCell) without an SSB (SSB-less). In another aspect, the CSSF values can be derived for secondary component carriers (SCCs) of secondary cells (SCells) without an SSB (SSB-less). As described herein, the CSSF scales the measurement delay requirement when the UE 106 is configured to monitor multiple measurement objects (MO). The CSSFs are categorized for measurements conducted outside measurement gaps. The UE 106 can conduct the measurement of the measurement object (i) outside the measurement gap. The CSSF is designated as CSSF_{outside_gap,i}. The CSSF value is based on components that account for measurement objects. As described herein, the CSSF value can be reduced to account for an SSB-less PSCell and a PSCC with only a CSI-RS based L3 measurement configured. In one example, the components used to derive the CSSF can be determined in the notes, and namely notes 6 and 7. However, this is not intended to be limiting. The components used to derive the CSSF may be located in other notes or sections of the 3GPP NR specification.

The UE 106 can have one or more processors 402 configured to identify, at the UE 106, one or more measurement objects (MOs) in the EN-DC network with CA. The MOs can comprise at least one MO configured for the PSCC of the PSCell. In one aspect, the processors 402 can decode, at the UE 106, information elements (IE) received from the network (NW) or gNB 102 to configure the UE 106 or the processors 402 to perform measurements. The IEs may configure the UE 106 to use a CSI-RS to perform channel state measurements, and/or an SSB to perform RRM measurements.

The processors 402 can determine, at the UE 106, a CSSF value to scale a measurement delay requirement. The CSSF value is for measurements of the MOs conducted outside the MGs and derived from the PSCell. In one aspect, the CSSF value can be: 1) increased when the PSCell includes a synchronization signal block (SSB), and 2) not increased when the PSCell is without an SSB (SSB-less). In another aspect, the CSSF value can be increased when the PSCC is with either both the SSB and a CSI-RS based Layer 3 (L3) measurement configured, or the PSCC is with only the CSI-RS based L3 measurement configured. The CSSF value cannot be increased when the PSCC is with only the CSI-RS based L3 measurement configured and the PSCell is SSB-less.

In another aspect, the CSSF (CSSF_{outside_gap,i}) can be derived by at least: 1+N_{PSCC_CSIRS}. Other components of the derivation, such as N_{PSCC_CCA_RSSI/CO}, remain unchanged and are not discussed further. As discussed above, the term “I” is a measurement object for the CSSF_{outside_gap}. When the PSCC is a PSCell with an SSB, the component N_{PSCC_CSIRS} is equal to 1 when the PSCC is with either both an SSB and a CSI-RS based Layer 3 (L3) measurement configured, or the PSCC is with only a CSI-RS based L3 measurement configured. When the PSCC is an SSB-less PSCell, the component N_{PSCC_CSIRS} is equal to 0 when the PSCC is with only a CSI-RS based L3 measurement configured. Otherwise N_{PSCC_CSIRS} is equal to 0 for all other cases. Thus, when the PSCC is an SSB-less PSCell, the component N_{PSCC_CSIRS} is reduced with respect to the legacy derivation, and the CSSF is also reduced.

In one aspect, the processors 402 of the UE 106 can be configured to derive, at the UE 106, the CSSF values. The processors 402 can be configured to determine, at the UE 106, when the PSCell is SSB-less. In another aspect, the processors 402 can be configured to decode, at the UE 106, a reference signal received from the NW or gNB 102 with the CSSF values. Thus, the NW or gNB 102 can derive the CSSF values.

The processors 402 can measure, at the UE 106, the MOs outside the MGs based on the measurement delay scaled by the CSSF value. The processors 402 can encode, at the UE 106, one or more measurement reports (MRs) for the MOs for transmission from the UE 106. The UE 106 can also have a memory 406 coupled to processors 402. The memory 406 can be configured to store the measurements and/or MRS.

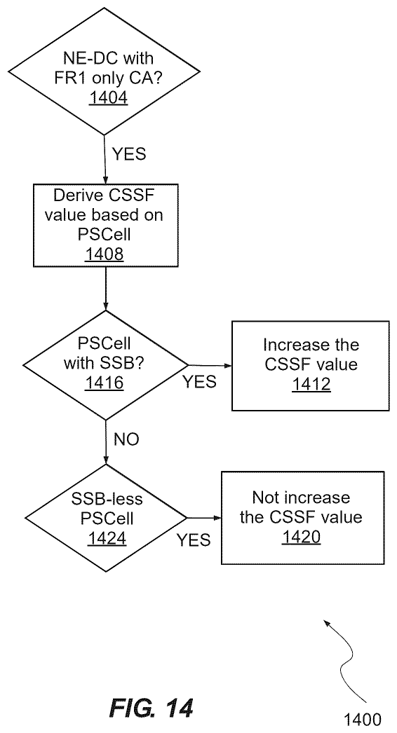

### FIG. 14: Flowchart for Derivation of CSSF Values

FIG. 14 illustrates example method 1400 for derivation of CSSF values. It is noted that the CSSF derivation of FIG. 14 is merely one example, and that features of this disclosure may be implemented in any of various systems, as desired.

A method 1400 can determine a CSSF value to scale a measurement delay requirement for measurements of MOs conducted outside MGs in an EN-DC network configured for FR1 with carrier aggregation (CA) 1404. The MOs can comprise at least one MO configured for a PSCC of a PSCell. The method 1400 can comprise deriving 1408 the CSSF value from the PSCell. As described herein, the CSSF value can be increased 1412 when the PSCell includes an SSB 1416, and not increased 1420 when the PSCell is without an SSB (SSB-less) 1424. Deriving the CSSF value can further comprise increasing the CSSF value when the PSCC is with either both the SSB and a CSI-RS based L3 measurement configured, or the PSCC is with only a CSI-RS based L3 measurement configured. Deriving the CSSF value can further comprise not increasing the CSSF value when the PSCC is with only a CSI-RS based L3 measurement configured. The CSSF (CSSF_{outside_gap,i}) can be derived as described above.

In another aspect, the CSSF values can be derived for secondary component carriers (SCCs) of secondary cells (SCells) without an SSB (SSB-less). The UE 106 can comprise one or more processors 402 configured to identify, at the UE 106, multiple MOs in a network, namely the EN-DC network, configured for FR1 with CA. The multiple MOs can comprise MOs configured for multiple SCCs of multiple SCells. The processors 402 can determine, at the UE 106, a CSSF value to scale a measurement delay requirement. The CSSF value is for measurements of the MOs conducted outside (MGs and derived from the SCells.

In one aspect, the CSSF value can be: 1) increased and scaled when the SCells include a synchronization signal block (SSB), and 2) increased and not scaled when the SCells are without an SSB (SSB-less). In another aspect, the CSSF value can be increased and scaled when the SCell is with either both the SSB and a CSI-RS based L3 measurement configured, or the SCell is with only the CSI-RS based L3 measurement configured. In another aspect, the CSSF value can be increased and not scaled when the SCell is SSB-less and is with only the CSI-RS based L3 measurement configured.

In another aspect, the CSSF (CSSF_{outside_gap,i}) can be derived by at least: N_{SSC_SSB}+Mx N_{SCC_CSIRS}. Other components of the derivation, such as Y and N_{PSCC_CCA_RSSI/CO}, remain unchanged and are not discussed further. As discussed above, the term “I” is a measurement object for the CSSF_{outside_gap}. The component N_{SCC_SSB} is equal to a number of SCell(s) with only an SSB based L3 measurement configured, which is measured without MG. When the SCC is an SCell with an SSB, the component N_{SCC_CSIRS} is equal to a number of SCell(s) with either both an SSB and a CSI-RS based L3 measurement configured or only a CSI-RS based L3 measurement configured, and M is equal to 2. In such case, the component N_{SCC_CSIRS} is scaled by the factor M, or “2×”. When the SCC is an SSB-less SCell, the component N_{SCC_CSIRS} is equal to a number of SCell(s) with only CSI-RS based L3 measurement configured, and M is equal to 1. In such a case, the component N_{SCC_CSIRS} is scaled by the factor M, or “1×”, and is thus not scaled.

In one aspect, the processors 402 can be configured to determine, at the UE 106, when the SCell is SSB-less. In another aspect, the processors 402 can be further configured to derive, at the UE 106, the CSSF value. In another aspect, the processors 402 can be further configured to decode, at the UE 106, a reference signal from a NW or gNB 102 including the CSSF value.

The processors 402 can measure, at the UE 106, the one or more MOs outside the MGs based on the measurement delay scaled by the CSSF value. The processors 402 can encode, at the UE 106, one or more MRs for the multiple MOs for transmission from the UE 106. The UE 106 can have a memory 406 coupled to the processors 402.

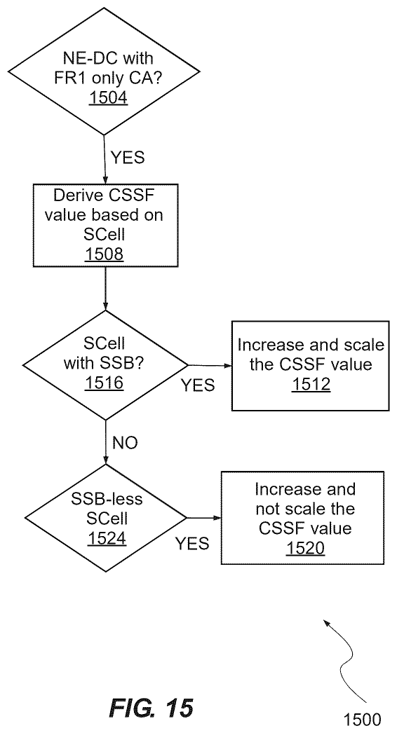

### FIG. 15: Flowchart for Derivation of CSSF Values to Scale a Measurement Delay

FIG. 15 illustrates example method 1500 for derivation of CSSF values. It is noted that the CSSF derivation of FIG. 15 is merely one example, and that features of this disclosure may be implemented in any of various systems, as desired.

A method 1500 can determine a CSSF value to scale a measurement delay requirement for measurements of MOs conducted outside MGs in a network configured for NE-DE FR1 with CA 1504 (or NR SA FR1 with CA, as discussed below). The multiple MOs can comprise at least one MO configured for multiple SCCs of multiple SCells. The method 1500 can comprise deriving 1508 the CSSF value from the SCell. The CSSF value can be: 1) increased and scaled 1512 when the SCells include a synchronization signal block (SSB) 1516, and 2) increased and not scaled 1520 when the SCells are without an SSB (SSB-less). The method of deriving the CSSF value further comprise increasing and scaling the CSSF value when the SCell is with either both the SSB and a CSI-RS based L3 measurement configured, or the SCell is with only the CSI-RS based L3 measurement configured. The method of deriving the CSSF value can further comprise increasing and not scaling the CSSF value when the SCell is SSB-less and is with only the CSI-RS based L3 measurement configured. The CSSF (CSSF outside_gap,i) can be derived as described above.

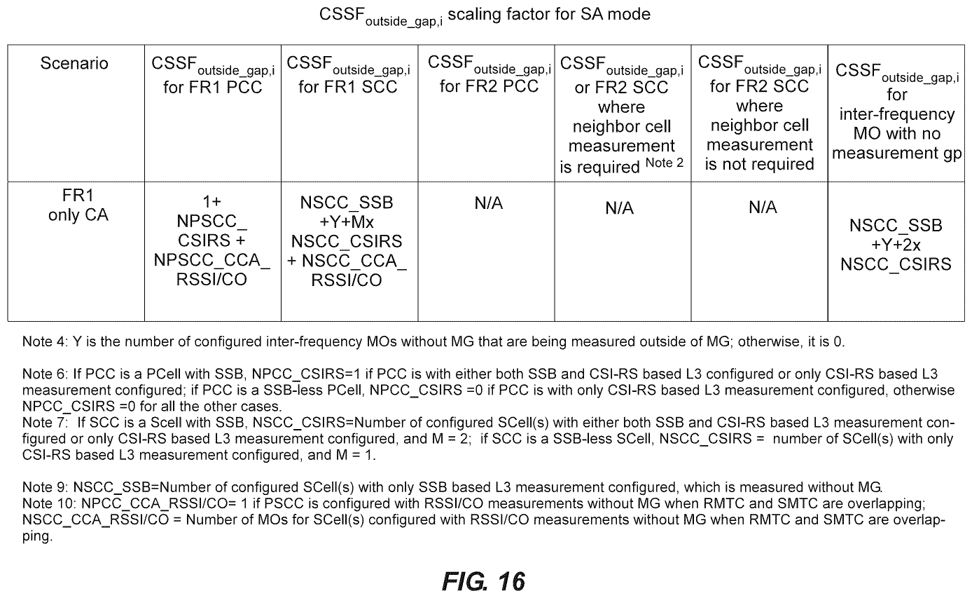

### FIG. 16: CSSF Redesigned for SA NR FR1 Only CA Scenario

FIG. 16 illustrates example derivations of CSSF values. It is noted that the CSSF derivation of FIG. 16 is merely one example, and that features of this disclosure may be implemented in any of various systems, as desired.

FIG. 16 illustrates derivations of CSSF values in a stand-alone (SA) new radio (NR) network configured for frequency range 1 (FR1) with carrier aggregation (CA). In one aspect, the CSSF values can be derived for a primary component carrier (PCC) of a primary cell (PCell) without an SSB (SSB-less). In another aspect, the CSSF values can be derived for secondary component carriers (SCCs) of secondary cells (SCells) without an SSB (SSB-less). As described herein, the CSSF scales the measurement delay requirement when the UE 106 is configured to monitor multiple measurement objects (MO). The CSSFs are categorized for measurements conducted outside measurement gaps. The UE 106 is expected to conduct the measurement of the measurement object (i) outside the measurement gap. The CSSF is designated as CSSF outside_gap,i. The CSSF value is based on components that account for measurement objects. As described herein, the CSSF value can be reduced to account for an SSB-less PSCell and a PSCC with only a CSI-RS based L3 measurement configured. The components used to derive the CSSF can be determined in the notes, and namely notes 6 and 7.

The UE 106 can comprise one or more processors 402 configured to identify, at the UE 106, one or more MOs in a stand-alone (SA) new radio (NR) network with carrier aggregation (CA). The one or more MOs can comprise at least one MO configured for a primary component carrier (PCC) of a primary cell (PCell). In one aspect, the processors 402 can decode, at the UE 106, information elements (IE) received from the network (NW) or gNB 102 to configure the UE 106 or the processors 402 to perform measurements. The IEs may configure the UE 106 to use a CSI-RS to perform channel state measurements, and/or an SSB to perform RRM measurements.

The processors 402 can determine, at the UE 106, a CSSF value to scale a measurement delay requirement. The CSSF value is for measurements of the MOs conducted outside MGs and derived from the PCell. In one aspect, the CSSF value can be: 1) increased when the PCell includes a synchronization signal block (SSB), and 2) not increased when the PCell is without an SSB (SSB-less). In another aspect, the CSSF value can be increased when the PCC is with either both the SSB and a CSI-RS based L3 measurement configured, or the PCC is with only CSI-RS based L3 measurement configured. In another aspect, the CSSF value cannot be increased when the PCC is with only CSI-RS based L3 measurement configured and the PCC is SSB-less.

In another aspect, the CSSF (CSSF_{outside_gap,i}) can be derived by at least: 1+N_{PCC_CSIRS}. Other components of the derivation, such as N_{PSCC_CCA_RSSI/CO}, remain unchanged and are not discussed further. As discussed above, the term “I” is a measurement object for the CSSF outside_gap. When the PCC is a PCell with an SSB, the component N_{PCC_CSIRS}=1 when the PCC is with either both an SSB and a CSI-RS based L3 configured, or the PCC is with only a CSI-RS based L3 configured. When the PCC is an SSB-less PCell, the component N_{PCC_CSIRS}=0 when the PCC is with only a CSI-RS based L3 measurement configured. Otherwise N_{PCC_CSIRS}=0 for all other cases. Thus, when the PCC is an SSB-less PCell, the component N_{PCC_CSIRS} is reduced with respect to the legacy derivation, and the CSSF is also reduced.

In one aspect, the processors 402 can be further configured to determine, at the UE 106, when the PCell is SSB-less. In another aspect, the processors 402 can be further configured to derive, at the UE 106, the CSSF value. In another aspect, the processors 402 can be further configured to decode, at the UE 106, a reference signal from the NW of gNB 102 including the CSSF value.

The processors 402 can measure, at the UE 106, the MOs outside the MGs based on the measurement delay scaled by the CSSF value. The processors 402 can encode, at the UE 106, one or more measurement reports (MRs) for the MOs for transmission from the UE 106. The UE 106 can also have a memory 406 coupled processors 402. The memory 406 can be configured to store the measurements and/or MRs.

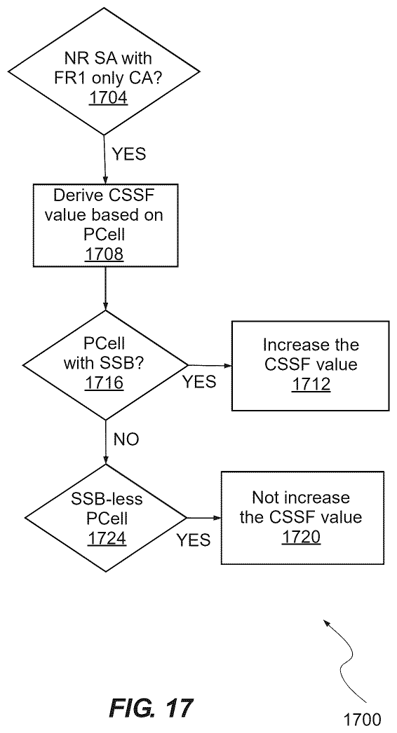

### FIG. 17: Flowchart for Derivation of CSSF Values to Scale a Measurement Delay

FIG. 17 illustrates example method 1700 for derivation of CSSF values. It is noted that the CSSF derivation of FIG. 17 is merely one example, and that features of this disclosure may be implemented in any of various systems, as desired.

A method 1700 can determine a CSSF value to scale a measurement delay requirement for measurements of one or more MOs conducted outside MGs in a NR SA network configured for FR1 with carrier aggregation CA. The MOs can comprise at least one MO configured for a PCC of a PCell. The method 1700 can comprise deriving 1708 the CSSF value from the PCell. The CSSF value can be: 1) increased 1712 when the PCell includes an SSB 1716, and 2) not increased 1720 when the PCell is without an SSB (SSB-less) 1724. Deriving the CSSF value can further comprise increasing the CSSF value when the PCC is with either both the SSB and a CSI-RS based L3 measurement configured, or the PCC is with only a CSI-RS based L3 measurement configured. Deriving the CSSF value can further comprise not increasing the CSSF value when the PSCC is with only a CSI-RS based L3 measurement configured. The CSSF (CSSF_{outside_gap,i}) can be derived as described above.

In another aspect, the CSSF values can be derived for SCCs of SCells without an SSB (SSB-less), as described above and with respect to FIGS. 13 and 15. With respect to block 1504 in FIG. 5, the condition would instead be NR SA with FR1 only CA, similar to block 1704 of FIG. 17.

Measurement of Neighbor Cell which has SSBs

If a serving SCell is in network energy saving (NES) mode, and some neighbor cells on a SCC have an SSB transmission, but other cells on this SCC are SSB-less, then the UE behavior can be clarified. As long as the SCell is SSB-less, a radio resource management (RRM) measurement of a neighbor cell on this SCC can be based on a CSI-RS based L3 measurement configuration. The UE can ignore the MO configuration of the SSB on this SCC. The UE can only use the MO configuration of the CSI-RS on this SCC.

If the SCell is SSB-less, the NW can indicate to the UE a cell list on this SCC indicating which are using an SSB and/or not using an SSB. In the MO configuration from the NW, the cell list can be provided to UE and can flags cells for the target cells in this cell list, such as an SSB-less cell or cell with an SSB.

If an SSB is configured on a neighbor cell on an SCC but a current SCell on this SCC is an SSB-less SCell, then intra-frequency and inter-frequency measurement can also be clarified. For the neighbor cells with SSB transmission on the SCC, if the SSB of the neighbor cell is inside the active BWP of current SCell, then measurement for this neighbor cell is categorized into intra-frequency measurement; otherwise it's inter-frequency measurement.

A wireless device, i.e. the UE 106, in a cellular communication system may typically perform neighbor cell measurements (e.g., measurements of cells which may be nearby other than a current serving cell) and serving cell measurements at various times, e.g., in addition to performing data and control communications. For example, such measurements may support continued good reception and facilitate cell handover and re-selection, among various other uses.

The UE 106 in any of the example herein can comprise processors 106 configured to identify, at the UE 106, a neighbor cell list in a MO from a secondary component carrier (SCC) of a neighbor secondary cell (SCell). Some neighbor cells on the SCC can have an SSB and other neighbor SCells on the SCC can be SSB-less. The cell list can identify neighbor cells with an SSB and neighbor cells that are SSB-less.

In one aspect, the processors 402 can be further configured to measure, at the UE 106, one or more MOs of the neighbor SSB-less cells using only a CSI-RS based L3 measurement configuration on the SCC. In another aspect, the processors 402 can be further configured to ignore, at the UE 106, an MO configuration of any SSB on the SCC.

In another aspect, the processors 402 can be further configured to measure, at the UE 106, one or more MOs of the neighbor cells with SSB in terms of intra-frequency measurement procedure when the SSB of the neighbor cell is inside an active bandwidth part (BWP) of a current SSB-less SCell. In another aspect, the processors 402 can be further configured to measure, at the UE 106, one or more MOs of the neighbor cells with SSB in terms of inter-frequency measurement procedure when the SSB of the neighbor cell is outside an active bandwidth part (BWP) of any current SSB-less SCell.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE), the apparatus comprising:
one or more processors configured to:
identify, at the UE, one or more measurement objects (MOs) in an Evolved Universal Terrestrial Radio Access (E-UTRA)-New Radio (NR) Dual Connectivity (EN-DC) network with carrier aggregation (CA);
wherein the one or more MOs comprise at least one MO configured for a primary secondary component carrier (PSCC) of a primary secondary cell (PSCell);
determine, at the UE, a carrier-specific scaling factor (CSSF) value to scale a measurement delay requirement, wherein the CSSF value is for measurements of the MOs conducted outside measurement gaps (MGs) and derived from the PSCell, wherein the CSSF value is:
increased when the PSCell includes a synchronization signal block (SSB), and
not increased when the PSCell is without an SSB (SSB-less);
measure, at the UE, the one or more MOs outside the MGs based on the measurement delay scaled by the CSSF value; and
encode, at the UE, one or more measurement reports (MRs) for the one or more measurement objects for transmission from the UE; and
a memory coupled to the one or more processors.

2. The apparatus of claim 1, wherein the one or more processors are further configured to determine the CSSF value wherein the CSSF value is:
increased when the PSCC is with either both the SSB and a channel status information-reference signal (CSI-RS) based Layer 3 (L3) measurement configured, or the PSCC is with only the CSI-RS based L3 measurement configured, and
not increased when the PSCC is with only the CSI-RS based L3 measurement configured and the PSCell is SSB-less.

3. The apparatus of claim 1, wherein the one or more processors are further configured to:
determine, at the UE, when the PSCell is SSB-less.

4. The apparatus of claim 1, wherein the CSSF (CSSF_{outside_gap,i}) is derived by at least:
1+N_{PSCC_CSIRS};
where:
i is a measurement object for the CSSF_{outside_gap};
when the PSCC is a PSCell with an SSB, N_{PSCC_CSIRS} is equal to 1 when the PSCC is with either both an SSB and a CSI-RS based Layer 3 (L3) measurement configured, or the PSCC is with only a CSI-RS based L3 measurement configured;
when the PSCC is an SSB-less PSCell, N_{PSCC_CSIRS} is equal to 0 when the PSCC is with only a CSI-RS based L3 measurement configured; and
otherwise N_{PSCC_CSIRS} is equal to 0 for all other cases.

5. The apparatus of claim 1, wherein the one or more processors are further configured to:
identify, at the UE, a neighbor cell list in a MO from a secondary component carrier (SCC) of a secondary cell (SCell);
wherein some neighbor cells on the SCC have an SSB and other neighbor SCells on the SCC are SSB-less; and
wherein the cell list identifies neighbor cells with an SSB and neighbor cells that are SSB-less.

6. The apparatus of claim 5, wherein the one or more processors are further configured to:
measure, at the UE, one or more MOs of the neighbor SSB-less cells using only a channel status information-reference signal (CSI-RS) based Layer 3 (L3) measurement configuration on the SCC.

7. The apparatus of claim 6, wherein the one or more processors are further configured to:
ignore, at the UE, an MO configuration of any SSB on the SCC.

8. The apparatus of claim 5, wherein the one or more processors are further configured to:
measure, at the UE, one or more MOs of the neighbor cells with SSB in terms of intra-frequency measurement procedure when the SSB of the neighbor cells is inside an active bandwidth part (BWP) of a current SSB-less SCell.

9. The apparatus of claim 5, wherein the one or more processors are further configured to:
measure, at the UE, one or more MOs of the neighbor cells with SSB in terms of inter-frequency measurement procedure when the SSB of the neighbor cells is outside an active bandwidth part (BWP) of any current SSB-less SCell.

10. The apparatus of claim 1, wherein the one or more processors are further configured to:
derive, at the UE, the CSSF value.

11. The apparatus of claim 1, wherein the one or more processors are further configured to:
decode, at the UE, a reference signal including the CSSF value.

12. A method for determining a carrier-specific scaling factor (CSSF) value to scale a measurement delay requirement for measurements of one or more measurement objects (MOs) conducted outside measurement gaps (MGs) in an Evolved Universal Terrestrial Radio Access (E-UTRA)-New Radio (NR) Dual Connectivity (EN-DC) network with carrier aggregation (CA), wherein the one or more MOs comprise at least one MO configured for a primary secondary component carrier (PSCC) of a primary secondary cell (PSCell), the method comprising:
deriving the CSSF value from the PSCell, wherein the CSSF value is:
increased when the PSCell includes a synchronization signal block (SSB), and
not increased when the PSCell is without an SSB (SSB-less).

13. The method of claim 12, wherein deriving the CSSF value further comprises:
increasing the CSSF value when the PSCC is with either both the SSB and a channel status information-reference signal (CSI-RS) based Layer 3 (L3) measurement configured, or the PSCC is with only a CSI-RS based L3 measurement configured, and
not increasing the CSSF value when the PSCC is with only a CSI-RS based L3 measurement configured.

14. The method of claim 12, wherein the CSSF (CSSF_{outside_gap,i}) is derived by at least:
1+N_{PSCC_CSIRS};
where:
i is a measurement object for the CSSF_{outside_gap};
when the PSCC is a PSCell with an SSB, N_{PSCC_CSIRS} is equal to 1 when the PSCC is with either both an SSB and a CSI-RS based Layer 3 (L3) measurement configured, or the PSCC is with only a CSI-RS based L3 measurement configured;
when the PSCC is an SSB-less PSCell, N_{PSCC_CSIRS} is equal to 0 when the PSCC is with only a CSI-RS based L3 measurement configured; and
otherwise N_{PSCC_CSIRS} is equal to 0 for all other cases.

15. An apparatus of a user equipment (UE), the apparatus comprising:
one or more processors configured to:
identify, at the UE, one or more measurement objects (MOs) in a stand-alone (SA) new radio (NR) network with carrier aggregation (CA);
wherein the one or more MOs comprise at least one MO configured for a primary component carrier (PCC) of a primary cell (PCell);
determine, at the UE, a carrier-specific scaling factor (CSSF) value to scale a measurement delay requirement, wherein the CSSF value is for measurements of the MOs conducted outside measurement gaps (MGs) and derived from the PCell, wherein the CSSF value is:
increased when the PCell includes a synchronization signal block (SSB), and
not increased when the PCell is without an SSB (SSB-less);
measure, at the UE, the one or more MOs outside the MGs based on the measurement delay scaled by the CSSF value; and
encode, at the UE, one or more measurement reports (MRs) for the one or more measurement objects for transmission from the UE; and
a memory coupled to the one or more processors.

16. The apparatus of claim 15, wherein the one or more processors are further configured to determine the CSSF value wherein the CSSF value is:
increased when the PCC is with either both the SSB and a channel status information-reference signal (CSI-RS) based Layer 3 (L3) measurement configured, or the PCC is with only CSI-RS based L3 measurement configured, and
not increased when the PCC is with only CSI-RS based L3 measurement configured and the PCC is SSB-less.

17. The apparatus of claim 15, wherein the one or more processors are further configured to:
determine, at the UE, when the PCell is SSB-less.

18. The apparatus of claim 15, wherein the CSSF (CSSF_{outside_gap,i}) is derived by at least:
1+N_{PCC_CSIRS};
where:
i is a measurement object for the CSSF_{outside_gap};
when the PCC is a PCell with an SSB, N_{PCC_CSIRS}=1 when the PCC is with either both an SSB and a CSI-RS based L3 configured, or the PCC is with only a CSI-RS based L3 configured;
when the PCC is an SSB-less PCell, N_{PCC_CSIRS}=0 when the PCC is with only a CSI-RS based L3 measurement configured; and
otherwise N_{PCC_CSIRS}=0 for all other cases.

19. The apparatus of claim 15, wherein the one or more processors are further configured to:
identify, at the UE, a neighbor cell list in a MO from a secondary component carrier (SCC) of a secondary cell (SCell);
wherein some neighbor cells have an SSB and other neighbor cells are SSB-less; and
wherein the cell list identifies neighbor cells with SSB and neighbor cells that are SSB-less.

20. The apparatus of claim 19, wherein the one or more processors are further configured to:
measure, at the UE, one or more MOs of the neighbor SSB-less cells using only a channel status information-reference signal (CSI-RS) based Layer 3 (L3) measurement configuration on the SCC; or
ignore, at the UE, an MO configuration of any SSB on the SCC; or
measure, at the UE, one or more MOs of the neighbor cells with SSB in terms of intra-frequency measurement procedure when the SSB of the neighbor cells is inside an active bandwidth part (BWP) of a current SSB-less SCell; or
measure, at the UE, one or more MOs of the neighbor cells with SSB in terms of inter-frequency measurement procedure when the SSB of the neighbor cells is outside an active bandwidth part (BWP) of any current SSB-less SCell; or
decode, at the UE, a reference signal including the CSSF value.

21.-47. (canceled)
